(19) United States
(12) Patent Application Publication
(10) Pub. No.: US 2025/0245361 A1
(43) Pub. Date: Jul. 31, 2025

(54) STORAGE DEVICE GENERATING ENCRYPTION KEY, ELECTRONIC DEVICE INCLUDING THE SAME, AND METHOD OF OPERATING ELECTRONIC DEVICE INCLUDING THE SAME

(71) Applicant: SAMSUNG ELECTRONICS CO., LTD., Suwon-si (KR)

(72) Inventors: Yejin YOON, Suwon-si (KR); Jisoo KIM, Suwon-si (KR); Sungho YOON, Suwon-si (KR); Younsung CHU, Suwon-si (KR)

(73) Assignee: SAMSUNG ELECTRONICS CO., LTD., Suwon-si (KR)

(21) Appl. No.: 18/776,890

(22) Filed: Jul. 18, 2024

(30) Foreign Application Priority Data
Jan. 31, 2024 (KR) 10-2024-0015222

(51) Int. Cl. G06F 21/60; G06F 9/455

(52) U.S. Cl. CPC G06F 21/606; G06F 9/45558; G06F 21/602; G06F 2009/45562; G06F 2009/45575

(57) ABSTRACT

Disclosed is an electronic device which includes a host device and a storage device. The host device may include a hypervisor, the host device configured to generate identification information corresponding to a first device function among one or more device functions of a storage device, generate a master key, and generate user secure information. The storage device comprising the one or more device functions, wherein the storage device is configured to assign the identification information to the first device function among the one or more device functions, and store the user secure information received from the host device and store the master key received from the host device, wherein the host device and the storage device are configured to perform an encrypted first data communication between the host device and the first device function using a host encryption key and a storage encryption key.

### CROSS-REFERENCE TO RELATED APPLICATIONS

This application claims priority under 35 U.S.C. § 119 to Korean Patent Application No. 10-2024-0015222 filed on Jan. 31, 2024, in the Korean Intellectual Property Office, the disclosures of which are incorporated by reference herein in their entireties.

### BACKGROUND

Embodiments of the present disclosure described herein relate to a storage device, and more particularly, relate to a storage device which generates an encryption key, an electronic device including the same, and a method of operating the electronic device including the same.

A memory device stores data depending on a write request and outputs the stored data depending on a read request. For example, a memory device is classified as a volatile memory device, in which stored data is lost when a power supply is cut off, such as a dynamic random access memory (DRAM) and a static RAM (SRAM), or as a non-volatile memory device, which retains stored data even when the power supply is cut off, such as a flash memory device, a phase-change RAM (PRAM), a magnetic RAM (MRAM) and a resistive RAM (RRAM).

A non-volatile memory device may also be referred to as a “storage device” which stores large amounts of data. Depending on a request from the host device, the storage device may store data, may output the stored data, or may delete the stored data. To ensure the security of data, encrypted data may be communicated between the host device and the storage device.

### SUMMARY

Embodiments of the present disclosure provide a storage device which generates an encryption key, an electronic device including the same, and a method of operating an electronic device including the same.

According to an embodiment, an electronic device includes a host device. A method of operating the electronic device includes providing, by the host device, first identification information to a first device function of the storage device; providing, by the host device, a master key to the storage device; providing, by the host device, first information of a first user of the host device to the storage device; generating, by the host device, a first host encryption key based on the first identification information, the first information, and the master key, wherein the first host encryption key is associated with the first device function, wherein a series of values of the first host encryption key are equal to a series of values of a first storage encryption key, wherein the first storage key is generated by the storage device and is based on the first identification information, the first information, and the master key, and wherein the first storage encryption key is associated with the first device function; and performing, by the host device and with the storage device, an encrypted first data communication between the host device and the first device function by using the first host encryption key and a first storage encryption key.

According to an embodiment, an electronic device includes a host device comprising a hypervisor, the host device configured to generate identification information corresponding to a first device function among one or more device functions of a storage device, generate a master key, and generate user secure information, and the storage device comprising the one or more device functions, wherein the storage device is configured to assign the identification information to the first device function among the one or more device functions, and store the user secure information received from the host device and store the master key received from the host device, wherein the host device generates a host encryption key based on the identification information, the user secure information, and the master key, wherein the host encryption key is associated with the first device function, wherein the storage device generates a storage encryption key based on the identification information, the user secure information, and the master key, wherein the storage encryption key is associated with the first device function, wherein a series of values of the host encryption key are equal to a series of values of the storage encryption key, and wherein the host device and the storage device are configured to perform an encrypted first data communication between the host device and the first device function using the host encryption key and the storage encryption key.

According to an embodiment, a storage device configured to communicate with a host device, the storage device including one or more device functions, the one or more device functions comprising a first device function, the first device function having first identification information assigned to it by the host device; and at least one memory for receiving a master key from the host device and storing instructions; wherein the instructions when executed by one or more processors, cause the storage device to: receive first secure information of a first user from the host device; generate a first storage encryption key based on the first identification information of the function manager, the first secure information, and the master key of the storage key table; and perform a first encrypted data communication between the host device and the first device function by using the first storage encryption key and a first host encryption key, wherein a series of values of the first host encryption key are equal to a series of values of the first storage encryption key, and wherein the first host encryption key and the first storage encryption key are associated with the first device function.

### BRIEF DESCRIPTION OF THE DRAWINGS

The above and other objects and features of the present disclosure will become apparent by describing in detail embodiments thereof with reference to the accompanying drawings.

FIG. 1 is a block diagram of an electronic device according to an embodiment of the present disclosure.

FIG. 2 is a diagram illustrating data communication of an electronic device in related art.

FIG. 3 is a diagram illustrating data communication of an electronic device according to embodiments of the present disclosure.

FIG. 4 is a block diagram of an electronic device according to some embodiments of the present disclosure.

FIG. 5 is a flowchart illustrating a method of operating an electronic device according to some embodiments of the present disclosure.

FIG. 6 is a flowchart illustrating an example of an enumeration operation of FIG. 5 according to some embodiments of the present disclosure.

FIG. 7 is a diagram illustrating identification information of an electronic device according to some embodiments of the present disclosure.

FIG. 8 is a diagram illustrating an example of a management operation of a master key of FIG. 5 according to some embodiments of the present disclosure.

FIG. 9 is a flowchart illustrating an exemplary operation of generating an encryption key of FIG. 5 according to some embodiments of the present disclosure.

FIG. 10 is a block diagram illustrating an exemplary host device which generates an encryption key according to some embodiments of the present disclosure.

FIG. 11 is a block diagram illustrating an exemplary storage device which generates an encryption key according to some embodiments of the present disclosure.

FIG. 12 is a diagram illustrating an example of data communication of FIG. 5 according to some embodiments of the present disclosure.

FIG. 13 is a diagram illustrating an example of data communication of FIG. 5 according to some embodiments of the present disclosure.

FIG. 14 is a diagram illustrating an exemplary update operation of an encryption key of FIG. 5 according to some embodiments of the present disclosure.

FIG. 15 is a diagram illustrating an exemplary update operation of an encryption key of FIG. 5 according to some embodiments of the present disclosure.

FIG. 16 is a flowchart illustrating a method of operating an electronic device according to some embodiments of the present disclosure.

### DETAILED DESCRIPTION

Hereinafter, embodiments of the present disclosure will be described clearly and in detail so that a person skilled in the technical field of the present disclosure may easily practice the embodiments of the present disclosure.

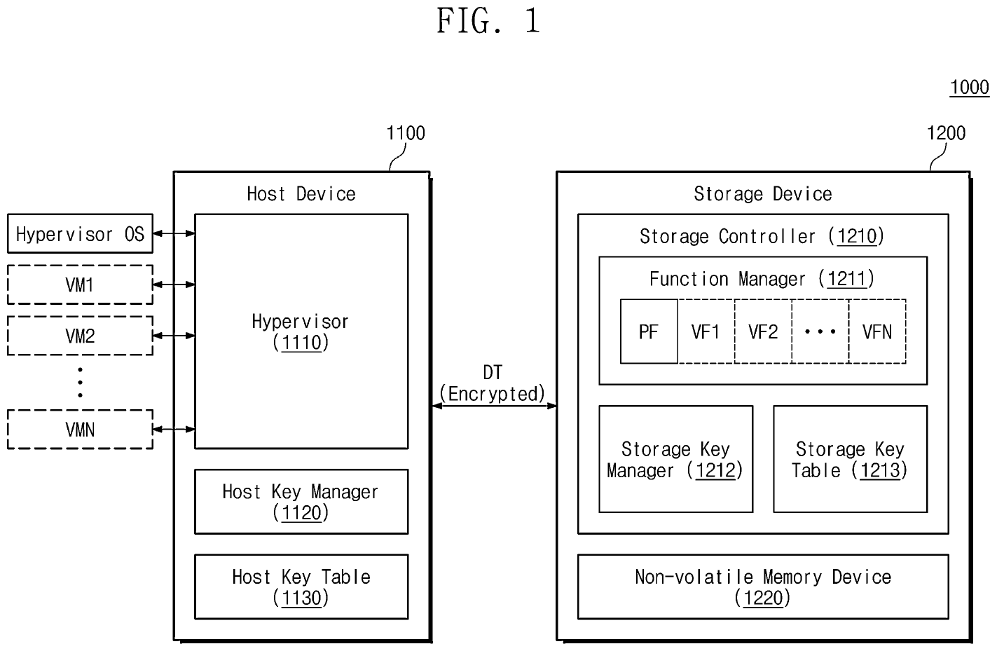

FIG. 1 is a block diagram of an electronic device according to an embodiment of the present disclosure. With reference to FIG. 1, an electronic device 1000 may process various information or may store processed information as data. In some embodiments, the electronic device 1000 may be implemented as a computing system such as a personal computer (PC), a notebook, a laptop, a server, a workstation, a tablet PC, a smartphone, a digital camera, a black box, etc. In addition, the electronic device 1000 may be implemented as a data center or a server device which manages large amounts of data for various users.

The electronic device 1000 may include a host device 1100 and a storage device 1200. The host device 1100 may control overall operations of the electronic device 1000. The host device 1100 and the storage device 1200 may encrypt data DT and may perform data communication by using the encrypted data DT.

For example, when the host device 1100 performs a write operation, the host device 1100 provides the encrypted data DT to the storage device 1200, and the storage device 1200 may decrypt the encrypted data DT, and the storage device 1200 may store the decrypted data DT.

As another example, when the host device 1100 performs a read operation, the storage device 1200 provides the encrypted data DT to the host device 1100, the host device 1100 may decrypt the encrypted data DT, and the host device 1100 may obtain the decrypted data DT.

The host device 1100 may include a hypervisor 1110, a host key manager 1120, and a host key table 1130. At least some of the functions of the hypervisor 1110, the host key manager 1120, and the host key table 1130 may be implemented as software. For example, the host device 1100 may include a processor and a memory. The processor may perform functions implemented in software by loading instructions stored in the memory and executing the loaded instructions.

The hypervisor 1110 may be software which manages a virtual machine VM. For example, the hypervisor 1110 may run a hypervisor operating system (OS) and a plurality of virtual machines VM1 to VMN. “N” is any natural number. A hypervisor OS may correspond to an actual physical machine (i.e., the electronic device 1000). The hypervisor OS may be a basic OS which manages the data DT in association with the users and distributes resources (e.g., power, amount of computation, a storage space, bandwidth, etc.) of the electronic device. The hypervisor OS may be basically run while the hypervisor 1110 operates.

The plurality of virtual machines VM1 to VMN may be driven by the hypervisor 1110. The plurality of virtual machines VM1 to VMN use the resources of a physical machine (i.e., the electronic device 1000), but may operate as independent devices provided separately from the physical machine. Each of the plurality of virtual machines VM1 to VMN may run a plurality of virtual machine OSs, respectively. The virtual machine OS may be run while a corresponding virtual machine is running normally. The plurality of virtual machine OSs may manage the data DT in association with the users of the hypervisor OS and a plurality of remaining users. As the hypervisor 1110 runs the plurality of virtual machines VM1 to VMN, a multi-tenant environment similar to providing multiple devices to each of multiple users may be provided.

In some embodiments, the hypervisor 1110 may manage the plurality of virtual machines VM1 to VMN by reflecting a usage environment of the electronic device 1000. For example, when a new user of the electronic device 1000 is added, the hypervisor 1110 may allocate resources for the added user and may run an additional virtual machine by using the allocated resources.

As another example, when a user of one of the plurality of virtual machines VM1 to VMN finishes using the virtual machine, the hypervisor 1110 terminates the unused virtual machine and recalls the resources of the terminated virtual machine. The recalled resources may be allocated for other virtual machines or may be utilized in association with other operations of the host device 1100.

The hypervisor 1110 may manage identification information. For example, the hypervisor 1110 may perform an enumeration operation in association with a physical function (PF), a virtual function (VF), and the like which manages a plurality of device functions (e.g., I/O (Input/Output) of the data DT) supported by the storage device 1200 connected to the host device 1100.

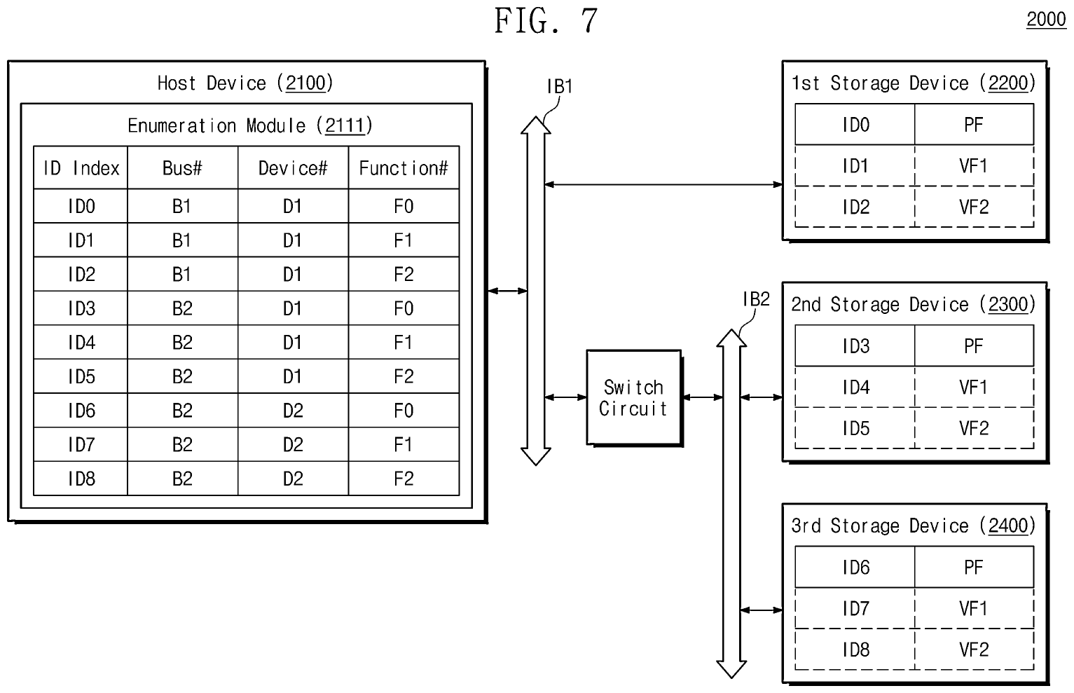

The enumeration operation may be used to assign unique identification information to each of the plurality of device functions. The identification information may include at least one of bus identification information, device identification information, and function identification information, and a more detailed description thereof will be written later with reference to FIG. 7. The identification information may also be provided to a user who exclusively uses the device functions.

The host key manager 1120 may manage encryption keys used for data communication between the host device 1100 and the storage device 1200. For example, the host key manager 1120 may generate a master key and secure information. The master key may include a series of values commonly generated in association with multiple users. The master key may also be referred to as “master key information”. The secure information may include a series of values exclusively generated for an individual user. The host key manager 1120 may receive the identification information of the device function dedicated to an individual user from the hypervisor 1110. The host key manager 1120 may generate an encryption key based on the identification information, the secure information, and the master key. The encryption key generated by the host key manager 1120 may also be referred to as a “host encryption key”. The encryption key may also be referred to as “encryption key information”. The encryption key may include a unique series of values.

The encryption key may be generated exclusively for a specific user. The encryption key may be used to perform encrypted data communication exclusively between a specific user of the host device 1100 and a corresponding device function of the storage device 1200. As the encryption key is differently used for each user, even though the encryption key of a specific user is leaked out, the security of the encryption key of other users is maintained and the security of the data DT may be improved in a multi-tenant environment.

The host key table 1130 may receive the master key from the host key manager 1120. The host key table 1130 may store the master key. The host key manager 1120 may generate an encryption key by referring to the master key stored in the host key table 1130.

In addition, the host key table 1130 may receive the encryption key from the host key manager 1120. The host key table 1130 may store the encryption key. The host key manager 1120 may perform an encryption operation or a decryption operation for data communication with the storage device 1200 by referring to the encryption key stored in the host key table 1130.

The storage device 1200 may include a storage controller 1210 and a non-volatile memory device 1220. The storage controller 1210 may store the data DT in the non-volatile memory device 1220 under control of the host device 1100 or based on an algorithm of internal firmware, may read the stored data DT, or may delete the stored data DT.

The storage controller 1210 may include a function manager 1211, a storage key manager 1212, and a storage key table 1213. At least some of the functions of the function manager 1211, the storage key manager 1212, and the storage key table 1213 may be implemented in software. For example, the storage controller 1210 may include a processor and a memory. The processor may load instructions stored in the memory and execute the loaded instructions to perform functions implemented in software.

The function manager 1211 may manage I/O of the data DT in association with a plurality of users of the host device 1100 (e.g., users of the hypervisor OS and the plurality of virtual machines VM1 to VMN). For example, the function manager 1211 may include a single root input output virtualization (SR-IOV) function of a peripheral component interconnect express (PCIe) interface. The SR-IOV function may be a function of additionally generating virtual I/O ports in a PCIe device having a single root (or port). The storage device 1200 having the SR-IOV function may additionally generate virtual I/O ports in addition to the actual I/O ports and may provide the virtual I/O ports to the virtual machines VM1 to VMN executed by the host device 1100. Accordingly, the virtual machines VM1 to VMN may be provided with a virtual environment similar to an environment, in which the virtual machines VM1 to VMN are connected to a plurality of storage devices, respectively.

The SR-IOV function supported by the function manager 1211 may include the physical function PF and the virtual function VF. The physical function PF may be activated based on a power supply voltage supplied from the host device 1100. The activated physical function PF may search for devices connected through the PCIe interface (e.g., the host device 1100, the virtual machines VM1 to VMN), may manage the found devices, and may generate the virtual function VF for communication with a virtual device among the found devices.

The physical function PF may generate or may delete virtual functions VF1 to VFN corresponding to each of the virtual machines VM1 to VMN in response to the request of the host device 1100. The generated virtual functions VF1 to VFN may manage I/Os in association with the virtual machines VM1 to VMN, respectively (e.g., perform a function on I/O). The physical function PF and the virtual function VF may also be referred to as a “device function”, respectively. The device function may manage I/O of data in association with a user of a corresponding physical or virtual machine.

A plurality of device functions of the function manager 1211 may be assigned identification information by the hypervisor 1110 of the host device 1100. For example, the hypervisor 1110 may assign the identification information to the physical function PF by performing an enumeration operation. The hypervisor 1110 may equally assign the identification information to a user of the hypervisor OS who exclusively uses the physical function PF. As another example, the hypervisor 1110 may assign a plurality of identification information to a plurality of virtual functions VF1 to VFN by performing an enumeration operation. The hypervisor 1110 may equally assign the plurality of identification information to a plurality of users of the plurality of virtual machines VM1 to VMN who exclusively use the plurality of virtual functions VF1 to VFN.

The storage key manager 1212 may refer to the identification information assigned to the device function of the function manager 1211. The storage key manager 1212 may receive the master key from the host device 1100 through the function manager 1211, may store the master key in the storage key table 1213, and may refer to the master key stored in the storage key table 1213. The storage key manager 1212 may receive secure information from the host device 1100 through the function manager 1211. The storage key manager 1212 may temporarily store the secure information.

The storage key manager 1212 may generate an encryption key based on the identification information, the secure information, and the master key. The encryption key generated by the storage key manager 1212 may also be referred to as a “storage encryption key”. The encryption key may include a unique series of values. A series of values of the encryption key may be equal to the series of values of the encryption key generated for the corresponding user by the host key manager 1120.

The storage key table 1213 may receive the master key from the storage key manager 1212. The storage key table 1213 may store the master key. The storage key manager 1212 may generate the encryption key by referring to the master key stored in the storage key table 1213.

In addition, the storage key table 1213 may receive the encryption key from the storage key manager 1212. The storage key table 1213 may store the encryption key. The storage key manager 1212 may perform an encryption operation or a decryption operation for data communication with the host device 1100 by referring to the encryption key stored in the storage key table 1213.

The non-volatile memory device 1220 may include a plurality of memory chips. The plurality of memory chips may store the data DT under control of the storage controller 1210 or may provide the stored data DT to the storage controller 1210. The memory chips of the non-volatile memory device 1220 may maintain stored data even when power supply is cut off. For example, the memory chips of the non-volatile memory device 1220 may be implemented as a NAND (not and)-based flash memory device, a NOR (not or)-based flash memory device, a phase-change RAM (PRAM), a magnetic RAM (MRAM), a resistive RAM (RRAM), and the like.

In some embodiments, the plurality of memory chips of the non-volatile memory device 1220 may provide memory regions dedicated to each of the plurality of device functions of the function manager 1211. For example, at least some of the plurality of memory chips may provide a memory region dedicated to the physical function PF of the function manager 1211. At least some of the plurality of memory chips may provide a plurality of memory regions dedicated to the virtual functions VF1 to VFN of the function manager 1211, respectively.

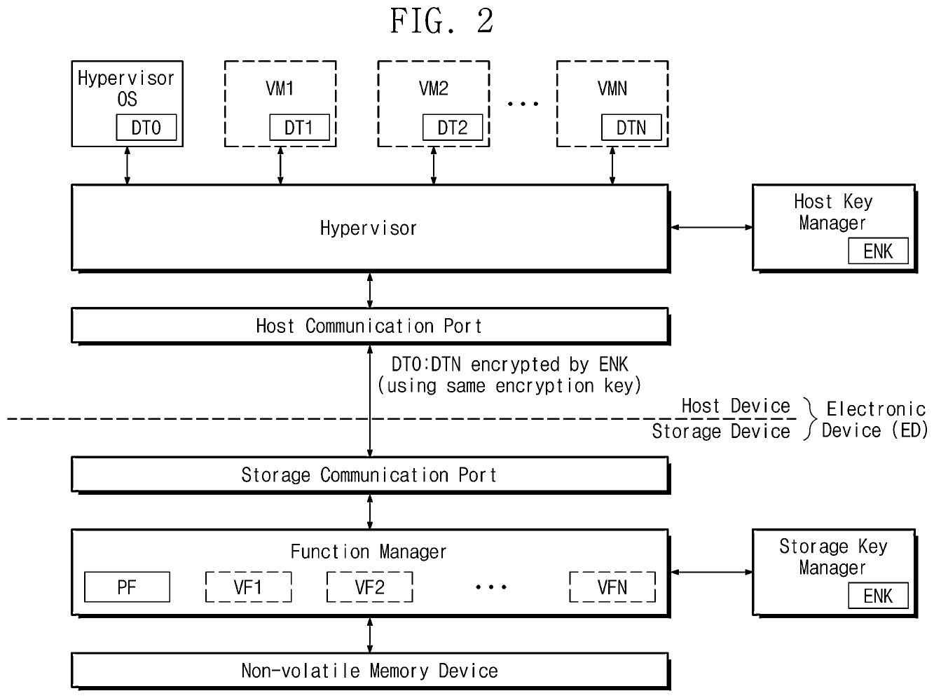

FIG. 2 is a diagram explaining data communication of a conventional electronic device. With reference to FIG. 2, a conventional electronic device ED may perform data communication in association with a plurality of data DT0 to DTN. Although the conventional electronic device ED is described for better understanding of the present disclosure, the conventional electronic device ED may include technical features not disclosed in the prior literature, and features of the conventional electronic device ED are not intended to limit the scope of the present disclosure.

The conventional electronic device ED may include a host device and a storage device. The host device may include a hypervisor, a host key manager, and a host communication port. The hypervisor may drive the hypervisor OS and the plurality of virtual machines VM1 to VMN. The user of the hypervisor OS may request an operation for the data DT0. A plurality of users of the plurality of virtual machines VM1 to VMN may request operations for a plurality of data DT1 to DTN, respectively. The host key manager may generate an encryption key ENK in association with a user of the hypervisor OS and users of the plurality of virtual machines VM1 to VMN. The host communication port may be electrically connected to a storage communication port of the storage device.

The storage device may include a storage communication port, a function manager, a storage key manager, and a non-volatile memory device. The storage communication port may be electrically connected to the host communication port of the host device. The function manager may include the physical function PF and the plurality of virtual functions VF1 to VFN. The physical function PF may manage I/O of the data DT0 for the user of the hypervisor OS. The physical function PF may generate the plurality of virtual functions VF1 to VFN. The plurality of virtual functions VF1 to VFN may manage I/Os of the data DT1 to DTN in association with users of the plurality of virtual machines VM1 to VMN, respectively. The storage key manager may manage the encryption key ENK in association with the physical function PF and the plurality of virtual functions VF1 to VFN. The non-volatile memory device may store the plurality of data DT0 to DTN received from the function manager or may provide the plurality of stored data DT0 to DTN to the function manager.

The conventional electronic device ED may perform data communication. For example, when performing a write operation, the host key manager may encrypt the plurality of data DT0 to DTN by using the encryption key ENK. The plurality of encrypted data DT0 to DTN may be provided to the physical function PF and the virtual functions VF1 to VFN of the function manager through the host communication port and the storage communication port. The storage key manager may decrypt the plurality of encrypted data DT0 to DTN by using the encryption key ENK. The function manager may store the plurality of decrypted data DT0 to DTN in the non-volatile memory device.

As another example, when performing a read operation, the non-volatile memory device may provide the plurality of data DT0 to DTN to the physical function PF and the virtual functions VF1 to VFN of the function manager in response to a read request from the host device. The storage key manager may encrypt the plurality of data DT0 to DTN by using the encryption key ENK. The plurality of encrypted data DT0 to DTN may be provided to the hypervisor through the storage communication port and the host communication port. The host key manager may decrypt the plurality of encrypted data DT0 to DTN by using the encryption key ENK. The plurality of decrypted data DT0 to DTN may be provided to a user of the hypervisor OS and users of the plurality of virtual machines VM1 to VMN.

As described above, the conventional electronic device ED may use one encryption key ENK in data communication of the plurality of data DT0 to DTN of a plurality of users. Because different users use the same encryption key, the user may access the encrypted data of other users, or when the encryption key is leaked out, the security of all the users of the host device may be vulnerable.

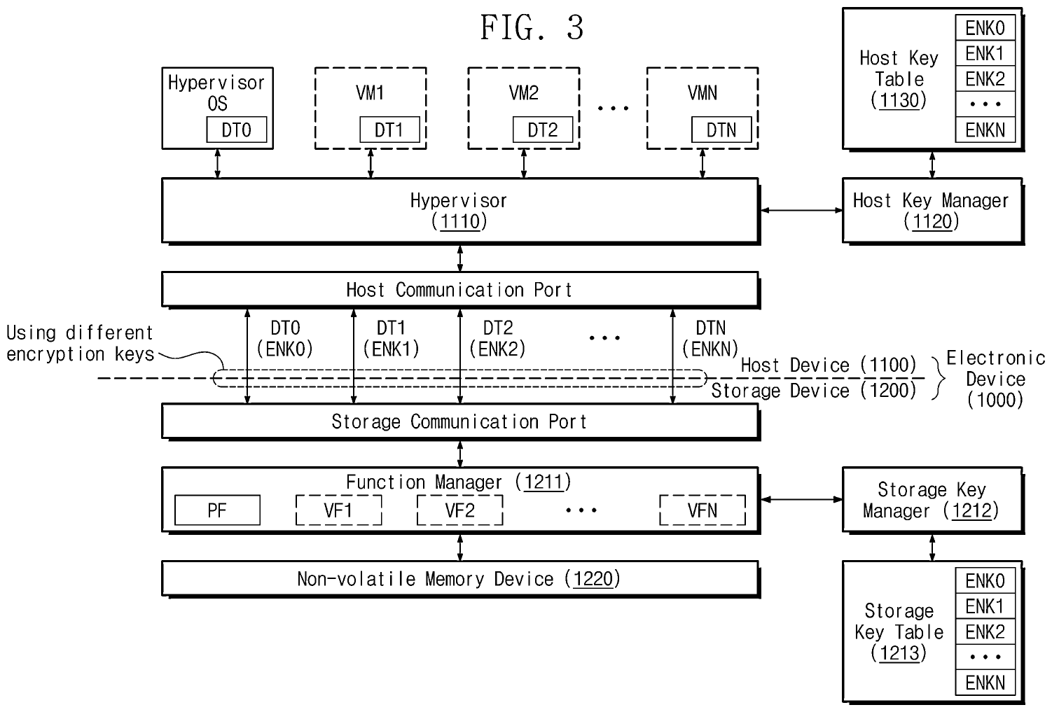

FIG. 3 is a diagram explaining data communication of an electronic device according to some embodiments of the present disclosure. With reference to FIG. 3, the electronic device 1000 may perform data communication with respect to the plurality of data DT0 to DTN. The electronic device 1000 may include the host device 1100 and the storage device 1200.

The host device 1100 may include the hypervisor 1110, the host key manager 1120, the host key table 1130, and the host communication port. The hypervisor 1110 may drive the hypervisor OS and the plurality of virtual machines VM1 to VMN. The user of the hypervisor OS may request an operation for the data DT0. A plurality of users of the plurality of virtual machines VM1 to VMN may request operations for the plurality of data DT1 to DTN, respectively.

The host key manager 1120 may generate an encryption key ENK0 for a user of the hypervisor OS. The host key manager 1120 may generate a plurality of encryption keys ENK1 to ENKN in association with users of the plurality of virtual machines VM1 to VMN. The host key manager 1120 may store a plurality of encryption keys ENK0 to ENKN in the host key table 1130. The host key manager 1120 may provide the storage key manager 1212 of the storage device 1200 with information (e.g., a plurality of identification information, a plurality of secure information, and a master key) necessary to generate the plurality of encryption keys ENK0 to ENKN.

The host key table 1130 may store the plurality of encryption keys ENK0 to ENKN received from the host key manager 1120. The host key manager 1120 may refer to the host key table 1130 to perform an encryption operation or a decryption operation. The host communication port may be electrically connected to the storage communication port of the storage device.

The storage device 1200 may include the storage communication port, the function manager 1211, the storage key manager 1212, the storage key table 1213, and the non-volatile memory device 1220. The storage communication port may be electrically connected to the host communication port of the host device. The function manager 1211 may include the physical function PF and the plurality of virtual functions VF1 to VFN. The physical function PF may manage I/O of the data DT0 for the user of the hypervisor OS. The physical function PF may generate the plurality of virtual functions VF1 to VFN. The plurality of virtual functions VF1 to VFN may manage I/Os of the data DT1 to DTN in association with users of the plurality of virtual machines VM1 to VMN, respectively.

The storage key manager 1212 may receive information (e.g., a plurality of identification information, a plurality of secure information, and a master key) necessary for the host key manager 1120 for generating the plurality of encryption keys ENK0 to ENKN from the host key manager 1120. The storage key manager 1212 may generate the plurality of encryption keys ENK0 to ENKN based on the information received from the host key manager 1120. The encryption key ENK0 may correspond to the physical function PF. The plurality of encryption keys ENK1 to ENKN may correspond to the plurality of virtual functions VF1 to VFN. The storage key manager 1212 may store the plurality of encryption keys ENK0 to ENKN in the storage key table 1213. The non-volatile memory device 1220 may store the plurality of data DT0 to DTN received from the function manager 1211 or provide the plurality of stored data DT0 to DTN to the function manager 1211.

The electronic device 1000 of the present disclosure may perform data communication. For example, when performing a write operation, the host key manager 1120 may encrypt the plurality of data DT0 to DTN by using the plurality of encryption keys ENK0 to ENKN stored in the host key table 1130. The plurality of encrypted data DT0 to DTN may be provided to the physical function PF and the virtual functions VF1 to VFN of the function manager 1211 through the host communication port and the storage communication port. The storage key manager 1212 may decrypt the plurality of encrypted data DT0 to DTN by using the plurality of encryption keys ENK0 to ENKN stored in the storage key table 1213. The function manager 1211 may store the plurality of decrypted data DT0 to DTN in the non-volatile memory device 1220.

As another example, when performing a read operation, the non-volatile memory device 1220 may provide the plurality of data DT0 to DTN to the physical function PF and the virtual functions VF1 to VFN of the function manager 1211 in response to a read request from the host device 1100. The storage key manager 1212 may encrypt the plurality of data DT0 to DTN by using the plurality of encryption keys ENK0 to ENKN stored in the storage key table 1213. The plurality of encrypted data DT0 to DTN may be provided to the hypervisor 1110 through the storage communication port and the host communication port. The host key manager 1120 may decrypt the plurality of encrypted data DT0 to DTN by using the encryption keys ENK0 to ENKN stored in the host key table 1130. The plurality of decrypted data DT0 to DTN may be provided to a user of the hypervisor OS and users of the plurality of virtual machines VM1 to VMN.

As described above, the electronic device 1000 of the present disclosure may use the plurality of encryption keys ENK0 to ENKN in the data communication of the plurality of data DT0 to DTN of the plurality of users. Because a unique encryption key is used for each user, it may be difficult for the user to access the encrypted data of other users, and the security of other users of the host device may be maintained even though the encryption key is leaked out. Accordingly, data security in the multi-tenant environment may be improved.

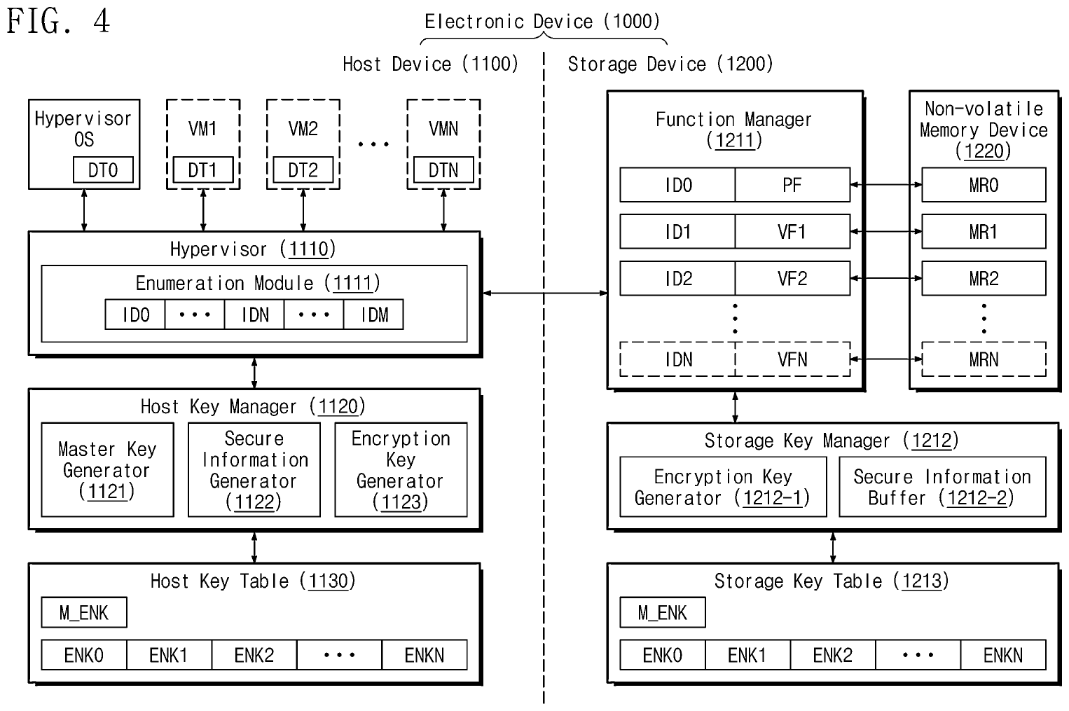

FIG. 4 is a block diagram of an electronic device according to some embodiments of the present disclosure. With reference to FIG. 4, the electronic device 1000 may include the host device 1100 and the storage device 1200.

The host device 1100 may include the hypervisor 1110, the host key manager 1120, and the host key table 1130. The hypervisor 1110 may drive the hypervisor OS and the plurality of virtual machines VM1 to VMN. The user of the hypervisor OS may request an operation for the data DT0. Users of the plurality of virtual machines VM1 to VMN may request operations in association with the plurality of data DT1 to DTN.

The hypervisor 1110 may include an enumeration module 1111. The enumeration module 1111 may perform an enumeration operation. For example, the enumeration module 1111 may generate a plurality of identification information ID0 to IDM in consideration of the maximum number of the device functions supported by the storage device 1200. “M” is a natural number greater than “N”. The enumeration module 1111 may assign the identification information ID0 to the user and the physical function PF of the hypervisor OS. After executing the plurality of virtual machines VM1 to VMN, the hypervisor 1110 may request the function manager 1211 to generate the plurality of virtual functions VF1 to VFN. Each of the plurality of virtual functions VF1 to VFN may have a plurality of identification information ID1 to IDN assigned by the enumeration module 1111. The enumeration module 1111 may assign the plurality of identification information ID1 to IDN to a plurality of users of the plurality of virtual machines VM1 to VMN which exclusively use the plurality of virtual functions VF1 to VFN. Thereafter, the user and the corresponding device function may be identified by the assigned identification information.

The host key manager 1120 may include a master key generator 1121, a secure information generator 1122, and an encryption key generator 1123. The master key generator 1121 may include a random number generation module. The secure information generator 1122 may include the random number generation module. In the same or another embodiment, the master key generator 1121 and the secure information generator 1122 may share the random number generation module.

The random number generation module may generate a unique series of values by using a random function based on ‘a national institute of standards and technology (NIST) special publication (SP) 800-90A’. For example, the random number generation module may be implemented by a hardware random number generator (HRNG) or by a true random number generator (TRNG).

The master key generator 1121 may generate a master key M_ENK having a unique series of values by using the random number generation module. The master key generator 1121 may store the master key M_ENK in the host key table 1130. The master key generator 1121 may provide the master key M_ENK to the storage key manager 1212 through the hypervisor 1110 and the function manager 1211. The storage key manager 1212 may store the master key M_ENK in the storage key table 1213.

The secure information generator 1122 may generate a plurality of secure information dedicated to a plurality of users, respectively. The secure information may include a series of values uniquely generated for a specific user and a specific device function by using the random number generation module. The secure information may be referred to as “function unique secure information”. For each of the plurality of pieces of secure information, the secure information generator 1122 may provide the secure information to the encryption key generator 1123 and may provide the secure information to the storage key manager 1212 through the hypervisor 1110 and the function manager 1211.

The encryption key generator 1123 may generate the plurality of encryption keys ENK0 to ENKN dedicated to a plurality of users, respectively. For example, the encryption key generator 1123 may obtain the identification information ID0 of the user of the hypervisor OS by referring to the hypervisor 1110, may receive the secure information of the user of the hypervisor OS from the secure information generator 1122, and may obtain the master key M_ENK stored in the host key table 1130. The encryption key generator 1123 may generate the encryption key ENK0 based on the identification information ID0, the secure information, and the master key M_ENK. The encryption key ENK0 may be used to encrypt data DT0 or decrypt the encrypted data DT0 in association with the data communication between the user and the physical function PF of the hypervisor OS. The encryption key generator 1123 may store the encryption key ENK0 in the host key table 1130.

The encryption key generator 1123 may obtain the identification information ID1 of the virtual machine VM1 of the user by referring to the hypervisor 1110, may receive the secure information of the virtual machine VM1 of the user from the secure information generator 1122, and may obtain the master key M_ENK stored in the host key table 1130. The encryption key generator 1123 may generate the encryption key ENK1 based on the identification information ID1, the secure information, and the master key M_ENK. The encryption key ENK1 may be used to encrypt the data DT1 or decrypt the encrypted data DT1 in association with the data communication between the user and the VF1 of the virtual machine VM1. The encryption key generator 1123 may store the encryption key ENK1 in the host key table 1130.

Similarly, the encryption key generator 1123 may generate second to Nth encryption keys ENK2 to ENKN, and store the second to Nth encryption keys ENK2 to ENKN in the host key table 1130.

The host key table 1130 may store the master key M_ENK and the plurality of encryption keys ENK0 to ENKN. The host key manager 1120 may encrypt the plurality of data DT0 to DTN provided from a plurality of users by using the plurality of encryption keys ENK0 to ENKN of the host key table 1130, or may decrypt the plurality of encrypted data DT0 to DTN received from the storage device 1200.

The storage device 1200 may include the function manager 1211, the storage key manager 1212, the storage key table 1213, and the non-volatile memory device 1220. The function manager 1211 may include the physical function PF and the virtual functions VF1 to VFN. The physical function PF may be provided with the identification information ID0 by the enumeration module 1111. The virtual functions VF1 to VFN may be provided with the identification information ID1 to IDN by the enumeration module 1111, respectively. The function manager 1211 may store a plurality of received identification information ID0 to IDN.

The physical function PF may manage I/O of the data DT0 of the user of the hypervisor OS. The physical function PF may use a memory area MR0 of the non-volatile memory device exclusively. The physical function PF may generate the virtual functions VF1 to VFN or may delete the generated VF in response to a request from the hypervisor 1110. The virtual functions VF1 to VFN may manage I/Os of the data DT1 to DTN of users of the virtual machines VM1 to VMN, respectively. Each of the virtual functions VF1 to VFN may use memory regions MR1 to MRN of the non-volatile memory device exclusively.

The storage key manager 1212 may include an encryption key generator 1212-1 and a secure information buffer 1212-2. The encryption key generator 1212-1 may store the master key M_ENK received from the host device 1100 in the storage key table 1213. The secure information buffer 1212-2 may store a plurality of pieces of secure information respectively dedicated to a plurality of users received from the host device 1100.

The encryption key generator 1212-1 may generate the plurality of encryption keys ENK0 to ENKN dedicated to a plurality of users, respectively. For example, the encryption key generator 1212-1 may obtain the identification information ID0 by referring to the physical function PF of the function manager 1211, may receive the secure information corresponding to the physical function PF from the secure information buffer 1212-2, and may obtain the master key M_ENK stored in the storage key table 1213. The encryption key generator 1212-1 may generate the encryption key ENK0 based on the identification information ID0, the secure information, and the master key M_ENK. The series of values of the encryption key ENK0 may be equal to the series of values of the encryption key ENK0 generated by the encryption key generator 1123 of the host device 1100. The encryption key generator 1212-1 may store the encryption key ENK0 in the storage key table 1213.

The encryption key generator 1212-1 may obtain the identification information ID1 by referring to the VF1 of the function manager 1211, may receive the secure information corresponding to VF1 from the secure information buffer 1212-2, and may obtain the master key M_ENK stored in the storage key table 1213. The encryption key generator 1212-1 may generate an encryption key ENK1 based on the identification information ID1, the secure information, and the master key M_ENK. The series of values of the encryption key ENK1 may be equal to the series of values of the encryption key ENK1 generated by the encryption key generator 1123 of the host device 1100. The encryption key generator 1212-1 may store the encryption key ENK1 in the storage key table 1213.

Similarly, the encryption key generator 1212-1 may generate the second to Nth encryption keys ENK2 to ENKN, and may store the second to Nth encryption keys ENK2 to ENKN in the storage key table 1213.

The storage key table 1213 may store the master key M_ENK and the plurality of encryption keys ENK0 to ENKN. The storage key manager 1212 may encrypt the plurality of data DT0 to DTN provided from the non-volatile memory device 1220 or may decrypt the plurality of encrypted data DT0 to DTN received from the host device 1100, by using the plurality of encryption keys ENK0 to ENKN of the storage key table 1213.

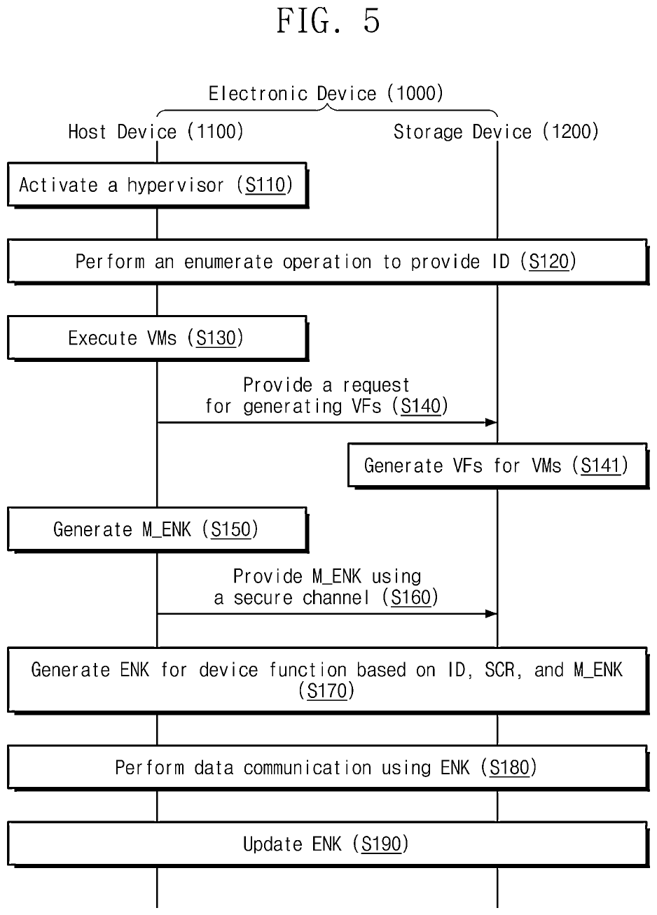

FIG. 5 is a flowchart explaining a method of operating an electronic device in response to some embodiments of the present disclosure. With reference to FIG. 5, the electronic device 1000 may include the host device 1100 and the storage device 1200.

In operation S110, the host device 1100 may activate the hypervisor. For example, the host device 1100 may receive an external power supply voltage and execute the hypervisor based on the external power supply voltage. While the hypervisor is being executed, the hypervisor OS may also be driven.

In operation S120, the host device 1100 and the storage device 1200 may perform the enumeration operation to provide the identification information ID. For example, the host device 1100 may generate the plurality of identification information ID in consideration of the device functions of the largest number supported by the storage device 1200. The host device 1100 may provide the plurality of identification information ID to the device functions of the largest number, respectively. The storage device 1200 may store the plurality of provided identification information ID. The device function may refer to the physical function PF or the VF. The host device 1100 may assign the identification information ID of the physical function PF to the user of the hypervisor OS.

In some embodiments, the host device 1100 may assign the identification information ID to the uncreated virtual function VF. For example, the storage device 1200 may include a physical integrated circuit corresponding to the VF. Before the virtual function VF is generated by the physical function PF, the host device 1100 may identify the physical integrated circuit corresponding to the virtual function VF supported by the storage device 1200. The host device 1100 may assign the identification information ID to the uncreated virtual function VF by referring to the identified physical integrated circuit.

In other words, the physical function PF generates the virtual function VF may mean activating the I/O function of data for the virtual machine by activating the physical integrated circuit by the physical function PF.

In operation S130, the host device 1100 may execute the plurality of virtual machines VM by a hypervisor. The host device 1100 may assign the plurality of identification information ID assigned by the enumeration operation to a plurality of users of the plurality of virtual machines VM, respectively. By the identification information ID, the virtual machine VM may be mapped to a corresponding VF which is not generated. Each of the plurality of virtual machines VM may execute the virtual machine OS and may perform an operation for a user of the virtual machine OS.

In operation S140, the host device 1100 may provide the storage device 1200 with a request for generating a plurality of virtual functions VF dedicated to each of the plurality of virtual machines VM.

In operation S141, the storage device 1200 may generate a plurality of virtual functions VF for the plurality of virtual machines VM based on the request. The plurality of virtual functions VF may have the plurality of identification information generated by the enumeration operation, respectively.

In operation S150, the host device 1100 may generate the master key M_ENK. The master key M_ENK may have a unique series of values generated by using the random number generation module. The master key M_ENK may be commonly used for a plurality of users.

In operation S160, the host device 1100 may establish a secure channel between the host device 1100 and the storage device 1200, and may provide the master key M_ENK to the storage device 1200 by using the established secure channel. Thereafter, the host device 1100 may delete the secure channel.

In operation S170, the host device 1100 may generate unique secure information SCR for a specific user. The host device 1100 may provide the secure information SCR to the storage device 1200. Each of the host device 1100 and the storage device 1200 may generate the encryption key ENK for the device function based on the identification information ID, the secure information SCR, and the master key M_ENK. Each of the host device 1100 and the storage device 1200 may store the encryption key ENK. Operation S170 may be repeatedly performed for each of a plurality of users.

In operation S180, the host device 1100 and the storage device 1200 may perform exclusive encrypted data communication between a user of the host device 1100 and the device function of the storage device 1200 by using the encryption key ENK. The encryption key ENK may be used to encrypt data transmitted from the host device 1100 to the storage device 1200 or data transmitted from the storage device 1200 to the host device 1100.

In operation S190, the host device 1100 and the storage device 1200 may update the encryption key ENK. For example, when the host device 1100 terminates the previously executed virtual machine VM, the host device 1100 may delete the encryption key ENK of the terminated virtual machine VM and request the storage device 1200 to delete the corresponding VF and the encryption key ENK. As another example, when the host device 1100 executes a new virtual machine VM, the host device 1100 may provide the storage device 1200 with a request for generating the virtual function VF dedicated to the new virtual machine VM. The encryption key ENK of the new virtual machine VM may be generated by the host device 1100 and the storage device 1200.

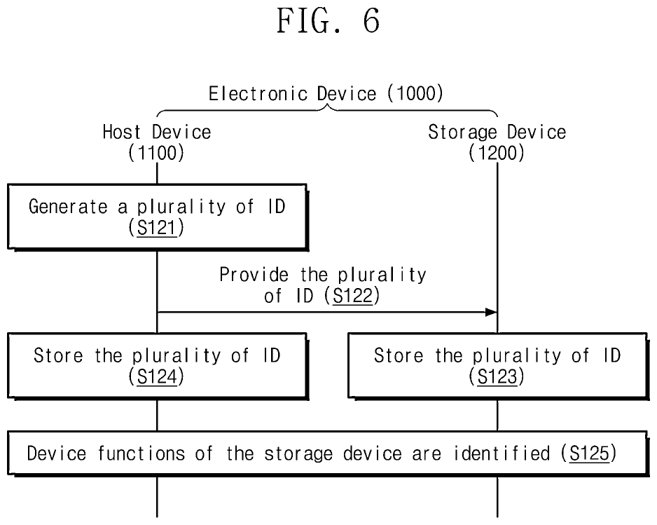

FIG. 6 is a flowchart explaining an example of an enumeration operation in FIG. 5, according to some embodiments of the present disclosure. With reference to FIG. 6, the electronic device 1000 may include the host device 1100 and the storage device 1200. Operation S121, operation S122, operation S123, operation S124, and operation S125 may correspond to operation S120 of FIG. 5.

In operation S121, the host device 1100 may generate the plurality of identification information ID. The plurality of identification information ID may be generated in consideration of the maximum number of the device functions supported by the storage device 1200.

In operation S122, the host device 1100 may provide the storage device 1200 with the plurality of identification information ID.

In operation S123, the storage device 1200 may map the plurality of device functions and the plurality of identification information ID, and store the plurality of mapped identification information ID. The identification information ID is not generated yet, but may also be mapped to the virtual function VF supported by the storage device 1200.

In operation S124, the host device 1100 may store the plurality of identification information ID. The host device 1100 may assign the identification information ID corresponding to the physical function PF to the user of the hypervisor OS.

In operation S125, the host device 1100 and the storage device 1200 may identify the device functions of the storage device 1200 by using the plurality of identification information ID. The identification information ID may be used for generating the virtual function VF in association with the virtual machine VM, generating an encryption key of a user, performing data communication, updating an encryption key, and the like.

FIG. 7 is a diagram explaining identification information of an electronic device, according to some embodiments of the present disclosure. With reference to FIG. 7, an electronic device 2000 may include a host device 2100, a first storage device 2200, a second storage device 2300, a third storage device 2400, a first interface bus IB1, a second interface bus IB2, and a switch circuit.

The first interface bus IB1 may be connected to the host device 2100, the first storage device 2200, and the switch circuit. The first interface bus IB1 may be implemented as a PCIe interface bus.

The switch circuit may be connected to the first interface bus IB1 and the second interface bus IB2. The switch circuit may be implemented as a PCIe/PCIe switch circuit.

The second interface bus IB2 may be connected to the switch circuit, the second storage device 2300, and the third storage device 2400. The second interface bus IB2 may be implemented as the PCIe interface bus.

The first storage device 2200 may include the physical function PF and the virtual functions VF1 and VF2. The second storage device 2300 may include the physical function PF and the virtual functions VF1 and VF2. The third storage device 2400 may include the physical function PF and the virtual functions VF1 and VF2.

The host device 2100 may include an enumeration module 2111. The enumeration module 2111 may manage the plurality of identification information on the plurality of device functions directly or indirectly connected to the host device 2100. For example, the enumeration module 2111 may assign the plurality of identification information ID0 to ID2 to the physical function PF and the virtual functions VF1 and VF2 of the first storage device 2200, respectively. The enumeration module 2111 may assign the plurality of identification information ID3 to ID5 to the physical function PF and the virtual functions VF1 and VF2 of the second storage device 2300, respectively. The enumeration module 2111 may assign the plurality of identification information ID6 to ID8 to the physical function PF and the virtual functions VF1 and VF2 of the third storage device 2400, respectively. The enumeration module 2111 may store the plurality of identification information ID0 to ID8.

The identification information may include the bus identification information, the device identification information, and the function identification information. Although an example of the identification information will be described for better understanding of the present disclosure, at least one of the bus identification information, the device identification information, and the function identification information may be omitted or other types of the identification information may be used together complying with the implementation method of the electronic device 2000.

The bus identification information may indicate an interface bus directly connected to the storage device including a device function having the identification information among a plurality of interface buses. For example, the identification information ID0 may be given to the physical function PF of the first storage device 2200. Values of the bus identification information of the first and second interface buses IB1 and IB2 may be “B1” and “B2”, respectively. The bus identification information of the identification information ID0 may have the value “B1” indicating the first interface bus IB1 directly connected to the first storage device 2200 including the physical function PF having the identification information ID0.

The device identification information may indicate the storage device including the device function having the identification information among at least one of the storage devices directly connected to the interface bus corresponding to the bus identification information. For example, the identification information ID0 may be given to the physical function PF of the first storage device 2200. The storage device directly connected to the first interface bus IB1 corresponding to the bus identification information of the value “B1” may be the first storage device 2200. The value of the device identification information of the first storage device 2200 may be “D1”. The device identification information of the identification information ID0 may have the value “D1” indicating the first storage device 2200.

The function identification information may indicate the device function having the identification information among the device functions of the storage device corresponding to the bus identification information and the device identification information. For example, the identification information ID0 may be given to the physical function PF of the first storage device 2200. The storage device corresponding to the bus identification information of a value of “B1” and device identification information of a value of “D1” may be the first storage device 2200. Values of the function identification information of the device functions “PF”, “VF1”, and “VF2” of the first storage device 2200 may be “F0”, “F1”, and “F2”, respectively. The function identification information of the identification information ID0 may have a value “F0” corresponding to “PF”.

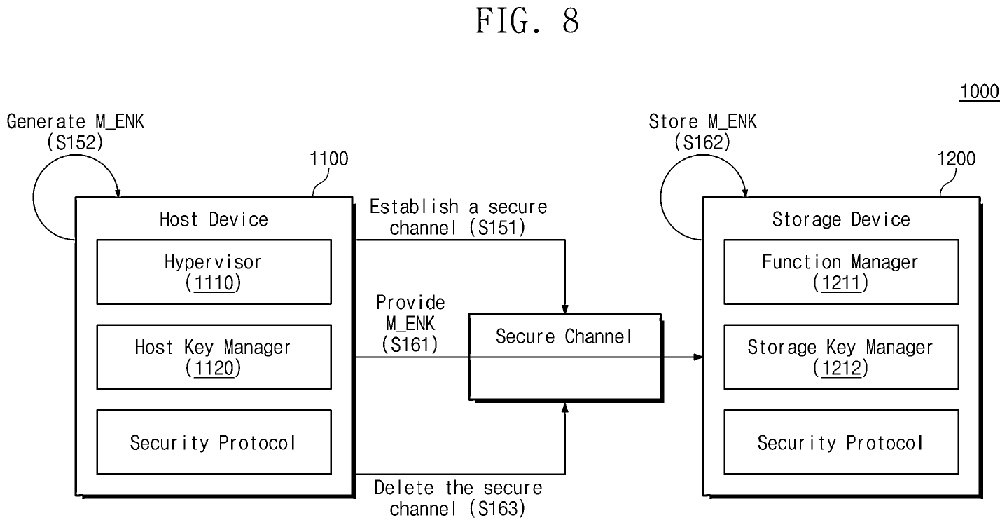

FIG. 8 is a diagram explaining an example of a master key management operation of FIG. 5 according to some embodiments of the present disclosure. With reference to FIG. 8, the electronic device 1000 may include the host device 1100 and the storage device 1200. The host device 1100 may include the hypervisor 1110 and the host key manager 1120. The host device 1100 may operate depending on a security protocol. The storage device 1200 may include the function manager 1211 and the storage key manager 1212. The storage device 1200 may operate depending on a security protocol. Operation S151 and operation S152 may correspond to operation S150 of FIG. 5. Operation S161, operation S162, and operation S163 may correspond to operation S160 of FIG. 5.

In operation S151, the host key manager 1120 may establish the secure channel depending on a security protocol. For example, the host key manager 1120 may establish the secure channel between the host device 1100 and the storage device 1200 by using a security protocol and data model (SPDM) security protocol. In operation S152, the host key manager 1120 may generate the master key M_ENK. The master key M_ENK may have a unique series of values generated by the random number generation module. In some embodiments, operation S151 and operation S152 may be performed simultaneously or may be performed in reverse order.

In operation S161, the host key manager 1120 may provide the master key M_ENK to the storage key manager 1212 through the secure channel. For example, the host key manager 1120 may provide the master key M_ENK to the storage key manager 1212 by using the IDE key management security protocol of the peripheral component interconnect express (PCIe) integrity and data encryption (IDE) standard on the secure channel. In operation S162, the storage key manager 1212 may store the master key M_ENK (e.g., in the storage key table 1213 of FIG. 4). In operation S163, the host key manager 1120 may delete the secure channel. For example, the host key manager 1120 may delete the secure channel by using the SPDM security protocol. Because the master key M_ENK is transmitted through the separate secure channel, a leakage of the master key M_ENK may be suppressed.

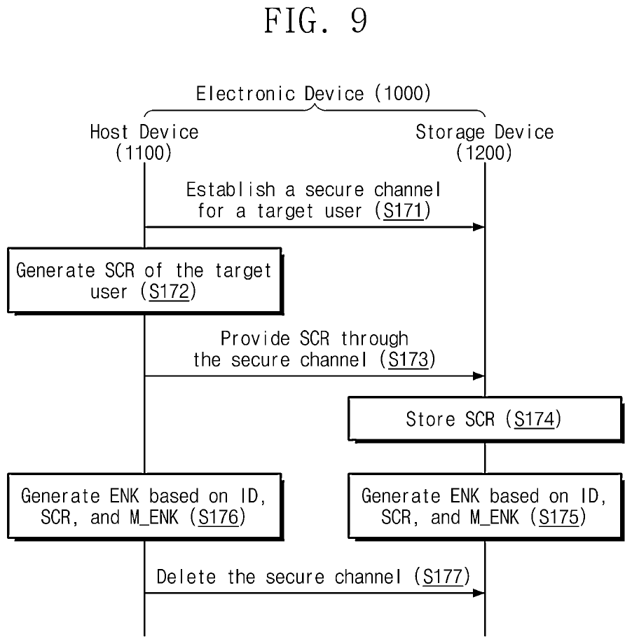

FIG. 9 is a flowchart explaining an example of an operation of generating an encryption key in FIG. 5 according to some embodiments of the present disclosure. With reference to FIG. 9, the electronic device 1000 may include the host device 1100 and the storage device 1200. Operation S171, operation S172, operation S173, operation S174, operation S175, operation S176, and operation S177 may correspond to operation S170 in FIG. 5.

In operation S171, the host device 1100 may establish the secure channel for a target user. The secure channel may be established in a manner similar to the secure channel of FIG. 8. The secure channel may be established individually for each user. For example, the target user may have the assigned identification information ID. The I/O of the data of the target user may be managed by a dedicated device function (e.g., PF or VF) in the storage device 1200. The dedicated device function may have the same identification information ID. The secure channel may be established exclusively between the target user and the device function.

In operation S172, the host device 1100 may generate the secure information SCR of a target user by using the random number generation module. The secure information SCR may include a series of values uniquely generated for a target user and a corresponding device function.

In operation S173, the host device 1100 may provide the secure information SCR to the storage device 1200 through the secure channel. Because the secure information SCR is transmitted through the secure channel, the leakage of the secure information SCR may be suppressed.

In operation S174, the storage device 1200 may store the secure information SCR (e.g., in the secure information buffer 1212-2 of FIG. 4).

In operation S175, the storage device 1200 may generate the encryption key ENK based on the identification information ID, the secure information SCR, and the master key M_ENK. The encryption key ENK may have a unique series of values in association with communication between a user and a device function. The encryption key ENK generated in the storage device 1200 may also be referred to as a “storage encryption key”.

In operation S176, the host device 1100 may generate the encryption key ENK based on the identification information ID, the secure information SCR, and the master key M_ENK. The series of values of the encryption key ENK may be equal to the series of values of the encryption key ENK generated in operation S175. The encryption key ENK generated in the host device 1100 may also be referred to as a “host encryption key”.

In operation S177, the host device 1100 may delete the secure channel for the target user. Operation S171, operation S172, operation S173, operation S174, operation S175, operation S176, and operation S177 may be further performed in a similar manner in association with other users.

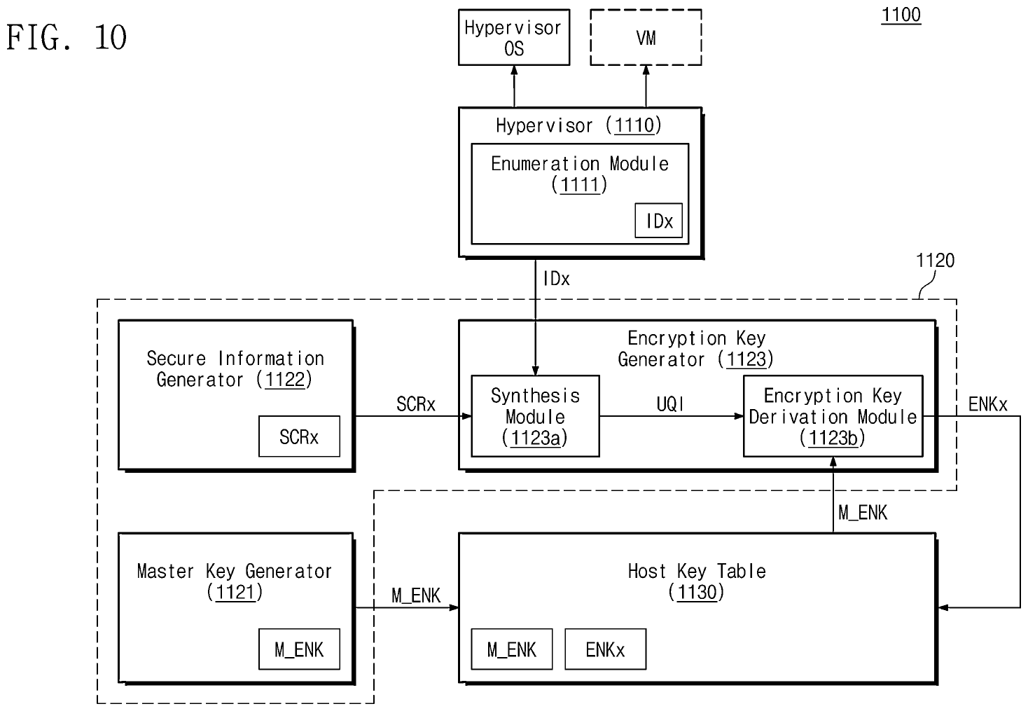

FIG. 10 is a block diagram explaining a host device which generates an encryption key according to some embodiments of the present disclosure. With reference to FIG. 9 and FIG. 10, the host device 1100 may include the hypervisor 1110, the host key manager 1120, and the host key table 1130. The generation of the encryption key ENK in FIG. 10 may correspond to operation S176 of FIG. 9.

The hypervisor 1110 may execute the hypervisor OS and the virtual machine VM. The target user may be a user of the hypervisor OS or a user of the virtual machine OS of the virtual machine VM. The hypervisor 1110 may include the enumeration module 1111. The enumeration module 1111 may assign identification information IDx to a device function of the storage device 1200 by an enumeration operation. The enumeration module 1111 may assign the identification information IDx to a user who is mapped to a device function. The enumeration module 1111 may provide the identification information IDx of the target user to the host key manager 1120.

The host key manager 1120 may include the master key generator 1121, the secure information generator 1122, and the encryption key generator 1123. The master key generator 1121 may store the master key M_ENK in the host key table 1130. The secure information generator 1122 may provide secure information SCRx for a target user to the encryption key generator 1123.

The encryption key generator 1123 may include a synthesis module 1123a and an encryption key derivation module 1123b. The synthesis module 1123a may receive the identification information IDx from the enumeration module 1111. The synthesis module 1123a may receive the secure information SCRx from the secure information generator 1122. The synthesis module 1123a may generate unique information UQI by synthesizing the identification information IDx and the secure information SCRx. The unique information UQI may have a unique series of values dedicated to a target user and a corresponding device function. The synthesis module 1123a may provide the unique information UQI to the encryption key derivation module 1123b.

The encryption key derivation module 1123b may receive the unique information UQI from the synthesis module 1123a. The encryption key derivation module 1123b may obtain the master key M_ENK by referring to the host key table 1130. The encryption key derivation module 1123b may generate an encryption key ENKx by performing a key derivation operation of the unique information UQI and the master key M_ENK based on the encryption key derivation algorithm. The encryption key derivation module 1123b may store the encryption key ENKx in the host key table 1130. The encryption key ENKx may be used for data communication between the target user and the corresponding device function.

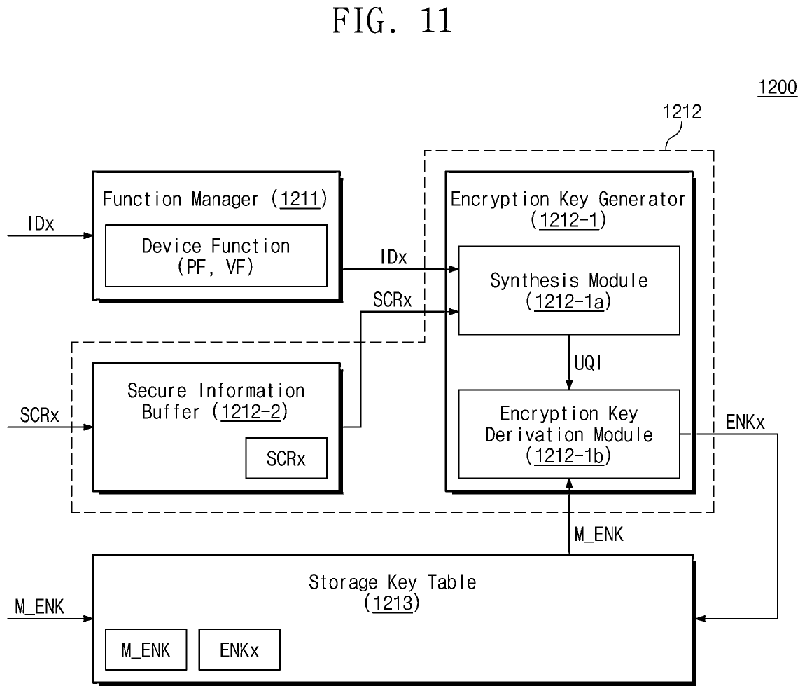

FIG. 11 is a block diagram explaining a storage device which generates an encryption key according to some embodiments of the present disclosure. With reference to FIG. 9 and FIG. 11, the storage device 1200 may include the function manager 1211, the storage key manager 1212, and the storage key table 1213. The generation of the encryption key ENK in FIG. 11 may correspond to operation S175 of FIG. 9.

The function manager 1211 may include a device function. The device function may be the physical function PF dedicated to the hypervisor OS or the virtual function VF dedicated to a virtual machine. The device function may have the identification information IDx assigned by the host device 1100. The function manager 1211 may store the assigned identification information IDx. The function manager 1211 may provide the identification information IDx to the storage key manager 1212.

The storage key manager 1212 may include the encryption key generator 1212-1 and the secure information buffer 1212-2. The secure information buffer 1212-2 may receive the secure information SCRx from the host key manager 1120 of FIG. 4 (e.g., via the hypervisor 1110 and the function manager 1211). The secure information buffer 1212-2 may store the secure information SCRx. The secure information buffer 1212-2 may provide the secure information SCRx to the encryption key generator 1212-1.

The storage key table 1213 may receive the master key M_ENK from the host key manager 1120 of FIG. 4 (e.g., through the hypervisor 1110, the function manager 1211, and the storage key manager 1212). The storage key table 1213 may store the master key M_ENK.

The encryption key generator 1212-1 may include a synthesis module 1212-1a and an encryption key derivation module 1212-1b. The synthesis module 1212-1a may receive the identification information IDx from the function manager 1211. The synthesis module 1212-1a may receive the secure information SCRx from the secure information buffer 1212-2. The synthesis module 1212-1a may generate the unique information UQI by synthesizing the identification information IDx and the secure information SCRx. The unique information UQI may have a unique series of values dedicated to a target user and a corresponding device function. The synthesis module 1212-1a may provide the unique information UQI to the encryption key derivation module 1212-1b.

The encryption key derivation module 1212-1b may receive the unique information UQI from the synthesis module 1212-1a. The encryption key derivation module 1212-1b may acquire the master key M_ENK by referring to the storage key table 1213. The encryption key derivation module 1212-1b may generate the encryption key ENKx by performing a key derivation operation of the unique information UQI and the master key M_ENK based on the encryption key derivation algorithm. The encryption key derivation module 1212-1b may store the encryption key ENKx in the storage key table 1213. The encryption key ENKx may be used for data communication between the target user and the corresponding device function.

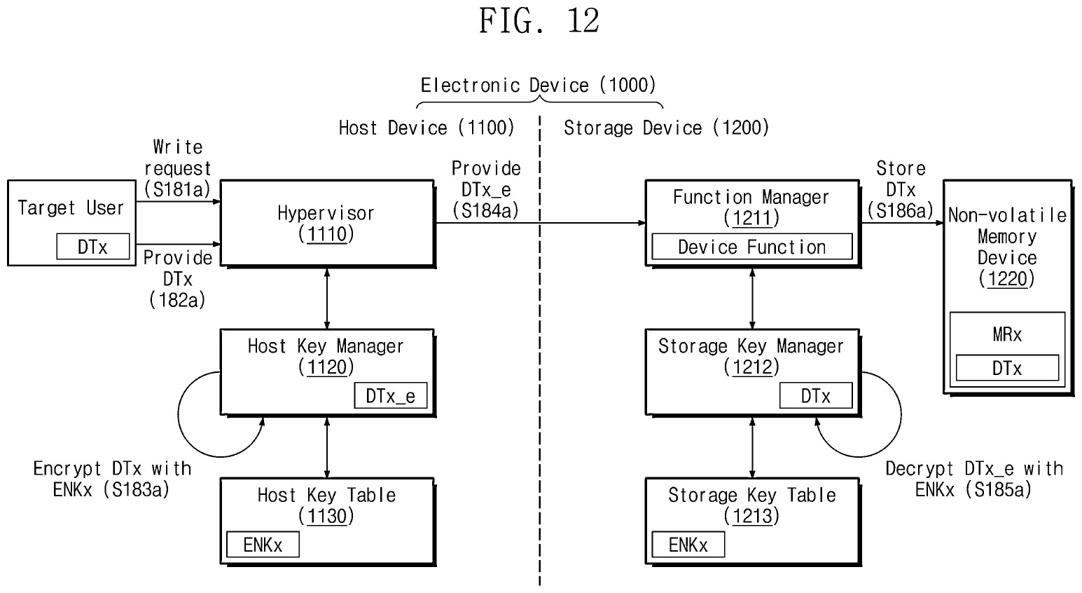

FIG. 12 is a diagram explaining an example of data communication in FIG. 5 according to some embodiments of the present disclosure. With reference to FIG. 5 and FIG. 12, the electronic device 1000 may include the host device 1100 and the storage device 1200. The host device 1100 may include the hypervisor 1110, the host key manager 1120, and the host key table 1130. The hypervisor 1110 may manage data in response to the request of the target user. The storage device 1200 may include the function manager 1211, the storage key manager 1212, the storage key table 1213, and the non-volatile memory device 1220. Operation S181a, operation S182a, operation S183a, operation S184a, operation S185a, and operation S186a may correspond to operation S180 of FIG. 5.

In operation S181a, a target user may generate a write request for target data DTx. A target user may provide a write request to the hypervisor 1110.

In operation S182a, the target user may provide the target data DTx corresponding to the write request to the hypervisor 1110.

In operation S183a, the host key manager 1120 may generate encrypted target data DTx_e by encrypting the target data DTx of the hypervisor 1110 by using the encryption key ENKx stored in the host key table 1130. The host key manager 1120 may provide the encrypted target data DTx_e to the hypervisor 1110.

In operation S184a, the hypervisor 1110 may provide the encrypted target data DTx_e to the device function of the function manager 1211.

In operation S185a, the storage key manager 1212 may restore the target data DTx by decrypting the encrypted target data DTx_e of the device function of the function manager 1211 by using the encryption key ENKx stored in the storage key table 1213. The storage key manager 1212 may provide the restored target data DTx to the device function of the function manager 1211.

In operation S186a, the device function of the function manager 1211 may store the restored target data DTx in a memory area MRx of the non-volatile memory device 1220. The memory area MRx may be an area dedicated to a target user and a device function.

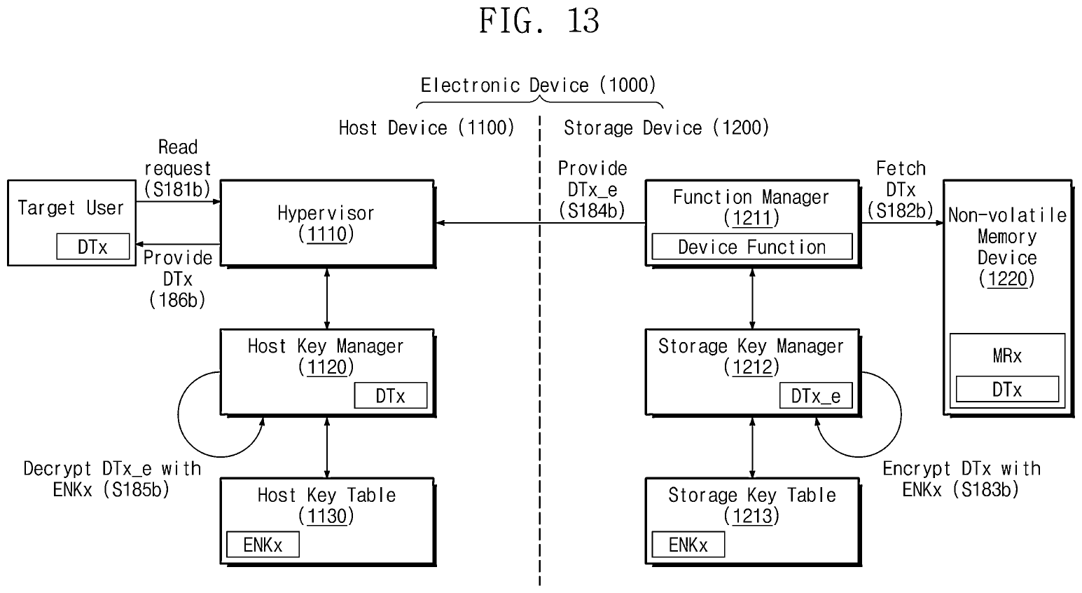

FIG. 13 is a diagram explaining an example of data communication of FIG. 5 according to some embodiments of the present disclosure. With reference to FIG. 5 and FIG. 13, the electronic device 1000 may include the host device 1100 and the storage device 1200. The host device 1100 may include the hypervisor 1110, the host key manager 1120, and the host key table 1130. The hypervisor 1110 may manage data in response to the request of the target user. The storage device 1200 may include the function manager 1211, the storage key manager 1212, the storage key table 1213, and the non-volatile memory device 1220. Operation S181b, operation S182b, operation S183b, operation S184b, operation S185b, and operation S186b may correspond to operation S180 of FIG. 5.

In operation S181b, a target user may generate a read request on the target data DTx stored in the storage device 1200. A target user may provide a read request to the storage device 1200 through the hypervisor 1110.

In operation S182b, the device function of the function manager 1211 may fetch the target data DTx stored in the memory area MRx of the non-volatile memory device 1220. The memory area MRx may be an area dedicated to a target user and a device function.

In operation S183b, the storage key manager 1212 may generate the encrypted target data DTx_e by encrypting the target data DTx of the device function of the function manager 1211 by using the encryption key ENKx stored in the storage key table 1213. The storage key manager 1212 may provide the encrypted target data DTx_e to the device function of the function manager 1211.

In operation S184b, the device function of the function manager 1211 may provide the encrypted target data DTx_e to the hypervisor 1110.

In operation S185b, the host key manager 1120 may decrypt the encrypted target data DTx_e of the hypervisor 1110 by using the encryption key ENKx stored in the host key table 1130, thereby restoring the target data DTx. The host key manager 1120 may provide the restored target data DTx to the hypervisor 1110.

In operation S186b, the hypervisor 1110 may provide the restored target data DTx to a target user. The target user may acquire the target data DTx corresponding to the read request.

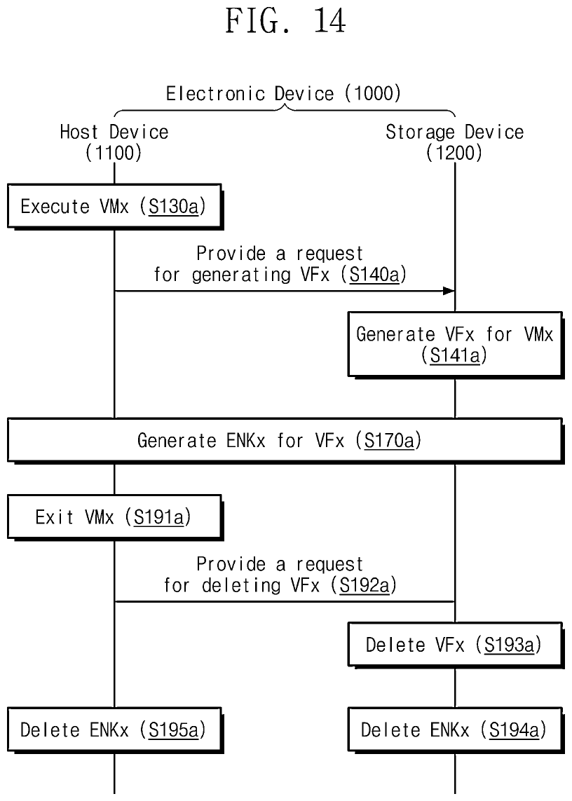

FIG. 14 is a diagram explaining an example of an operation of updating an encryption key of FIG. 5 according to some embodiments of the present disclosure. With reference to FIG. 5 and FIG. 14, the electronic device 1000 may include the host device 1100 and the storage device 1200. Operation S130a may correspond to operation S130 of FIG. 5. Operation S140a and operation S141a may correspond to operation S140 and operation S141 of FIG. 5. Operation S170a may correspond to operation S170 of FIG. 5. Operation S191a, operation S192a, operation S193a, operation S194a, and operation S195a may correspond to operation S190 of FIG. 5.

In operation S130a, the hypervisor of the host device 1100 may execute a virtual machine VMx for the target user. In operation S140a, the host device 1100 may provide the storage device 1200 with a request for generating a device function VFx corresponding to the virtual machine VMx. In operation S141a, the storage device may generate a device function VFx in association with the virtual machine VMx. In operation S170a, each of the host device 1100 and the storage device 1200 may generate the encryption key ENKx dedicated to the device function VFx of the target user.

In operation S191a, the host device 1100 may terminate the virtual machine VMx corresponding to the target user.

In operation S192a, the host device 1100 may provide the storage device 1200 with a request for deleting the device function VFx corresponding to the virtual machine VMx based on terminating the virtual machine VMx.

In operation S193a, the storage device 1200 may delete the device function VFx based on the request in operation S192a.

In operation S194a, the storage device 1200 may delete the encryption key ENKx of the target user based on the request in operation S192a.

In operation S195a, the host device 1100 may delete the encryption key ENKx of the target user based on terminating the virtual machine VMx.

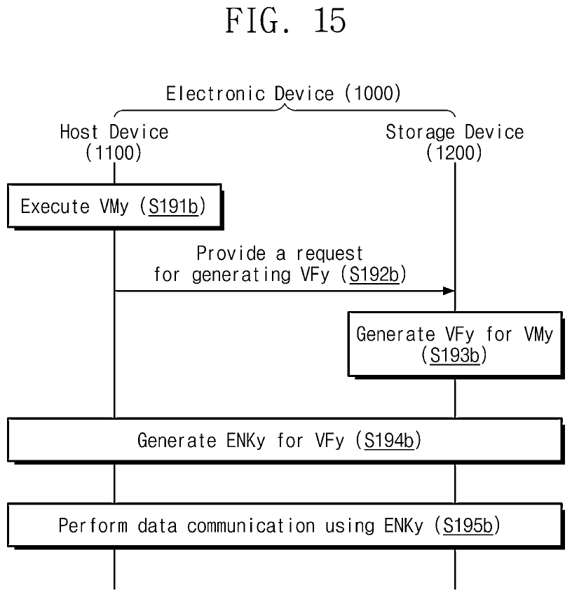

FIG. 15 is a diagram explaining an example of an operation of updating an encryption key of FIG. 5 according to some embodiments of the present disclosure. With reference to FIG. 5 and FIG. 15, the electronic device 1000 may include the host device 1100 and the storage device 1200. Operation S191b, operation S192b, operation S193b, operation S194b, and operation S195b may correspond to operation S190 of FIG. 5.

In operation S191b, the host device 1100 may execute a virtual machine VMy for a target user. The target user may be a new user who does not use the virtual machines VM in operation S130 of FIG. 5. That is, the virtual machine VMy may be executed after generating an encryption key in association with the previously executed virtual machine VM.

In operation S192b, the host device 1100 may provide the storage device 1200 with a request for generating a device function VFy corresponding to the virtual machine VMy for the target user based on executing the virtual machine VMy. In operation S193b, the storage device 1200 may generate the device function VFy for the virtual machine VMy depending on the request in operation S192b.

In operation S194b, each of the host device 1100 and the storage device 1200 may generate an encryption key ENKy dedicated to the device function VFy of the target user. Operation S194b may be performed similarly to operation S170 of FIG. 5. More specifically, the host device 1100 may provide secure information of a target user to the storage device 1200. The storage device 1200 may generate the encryption key ENKy based on the identification information of the target user, secure information of the target user, and the master key. The series of values of the encryption key ENKy may be different from the series of values of the encryption key generated for any other users. The host device 1100 may generate the encryption key ENKy based on the identification information of a target user, secure information of the target user, and the master key. The series of values of the encryption key ENKy generated by the host device 1100 may be equal to the series of values of the encryption key ENKy generated by the storage device 1200.

In operation S195b, the host device 1100 and the storage device 1200 may perform exclusive encrypted data communication between a target user and the device function VFy by using the encryption key ENKy. Operation S195b may be performed similarly to operation S180 of FIG. 5.

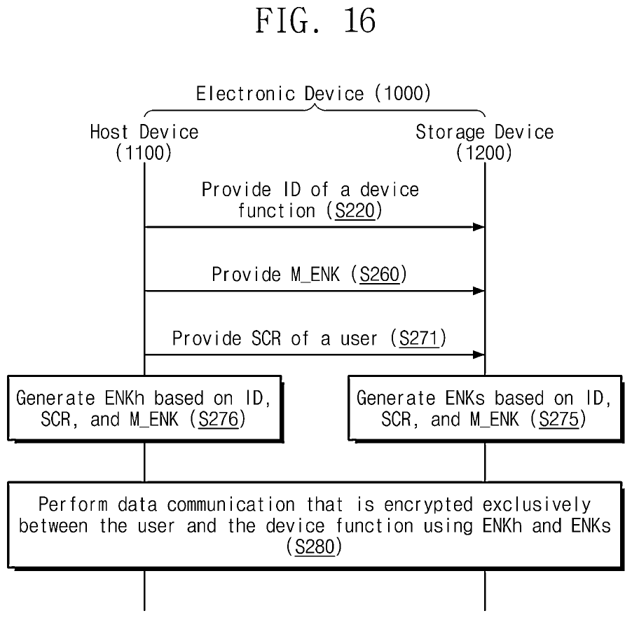

FIG. 16 is a flowchart explaining a method of operating an electronic device according to some embodiments of the present disclosure. With reference to FIG. 16, the electronic device 1000 may include the host device 1100 and the storage device 1200.

In operation S220, the host device 1100 may provide the identification information ID of the device function. The device function may refer to the physical function PF or the VF. The host device 1100 may assign the same identification information ID to a user who exclusively uses the device function.

In operation S260, the host device 1100 may provide the master key M_ENK to the storage device 1200. The master key M_ENK may include a series of values generated by using a random number generation module.

In operation S271, the host device 1100 may provide the storage device 1200 with the secure information SCR of the user who is given the identification information ID in operation S220. The secure information SCR may include a series of values uniquely generated in association with a pair of the user and the device function having the same identification information ID.

In operation S275, the storage device 1200 may generate a storage encryption key ENKs based on the identification information ID, the secure information SCR, and the master key M_ENK.

In operation S276, the host device 1100 may generate a host encryption key ENKh based on the identification information ID, the secure information SCR, and the master key M_ENK. The series of values of the host encryption key ENKh may be equal to the series of values of the storage encryption key ENKs.

In operation S280, the host device 1100 and the storage device 1200 may perform data communication exclusively encrypted between the user and the device function by using the host encryption key ENKh and the storage encryption key ENKs. For example, the host device 1100 may provide encrypted data to the storage device 1200 by using the host encryption key ENKh. In the same or another embodiment, the storage device 1200 may provide encrypted data to the host device 1100 by using the storage encryption key ENKs.

According to an embodiment of the present disclosure, a storage device which generates an encryption key, an electronic device including the same, and a method of operating the electronic device including the same are provided.

Additionally, a storage device with improved data security in a multi-tenant environment by setting the encryption key differently in association with each user and device function and by updating the encryption key to reflect a status of the user, an electronic device including the same, and a method of operating the electronic device including the same are provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method of operating an electronic apparatus, the electronic apparatus including a host device, and the method comprising:
providing, by the host device, first identification information to a first device function of the storage device;
providing, by the host device, a master key to the storage device;
providing, by the host device, first information of a first user of the host device to the storage device;
generating, by the host device, a first host encryption key based on the first identification information, the first information, and the master key,
wherein the first host encryption key is associated with the first device function,
wherein a series of values of the first host encryption key are equal to a series of values of a first storage encryption key,
wherein the first storage key is generated by the storage device and is based on the first identification information, the first information, and the master key, and
wherein the first storage encryption key is associated with the first device function; and
performing, by the host device and with the storage device, an encrypted first data communication between the host device and the first device function by using the first host encryption key and a first storage encryption key.

2. The method of claim 1, further comprising:
providing, by the host device, second identification information to a second device function of the storage device;
providing, by the host device, second information of a second user of the host device to the storage device;
generating, by the host device, a second host encryption key based on the second identification information, the second information, and the master key,
wherein a series of values of the second host encryption key are equal to the series of values of a second storage encryption key,
wherein the second storage encryption key is generated by the storage device and is based on the second identification information, the second information, and the master key,
wherein a series of values of the second storage encryption key are different from the series of values of the first storage encryption key;
wherein the second host encryption key and the second storage encryption key are associated with the second device function; and
performing, by the host device and with the storage device, an encrypted second data communication between the host device and the second device function by using the second host encryption key and the second storage encryption key.

3. The method of claim 1, wherein the host device is configured to run a hypervisor,
wherein the hypervisor runs a hypervisor operating system and a plurality of virtual machines,
wherein the first user is a user of the hypervisor operating system, or a user of a first virtual operating system of a first virtual machine among the plurality of virtual machines, and
wherein the encrypted first data communication between the host device and the first device function is performed between the hypervisor operating system and the first device function or the first virtual operating system and the first device function.

4. The method of claim 3, wherein the storage device supports a single root input output virtualization (SR-IOV), and
wherein the first device function is:
a physical function (PF) configured to manage transmission of data of the hypervisor operating system; or
a virtual function (VF) configured to manage transmission of data of one of the plurality of virtual operating systems of the plurality of virtual machines.

5. The method of claim 1, wherein the electronic device further comprises at least one storage device and a plurality of interface buses, and
wherein the first identification information comprises:
bus identification information indicating an interface bus connected to the storage device, the interface bus being among the plurality of interface buses;
device identification information indicating the storage device, the storage device being among at least one storage devices connected to the interface bus corresponding to the bus identification information; and
function identification information indicating the first device function among a plurality of device functions of the storage device.

6. The method of claim 1, wherein the providing of the master key to the storage device by the host device comprises:
establishing, by the host device, a secure channel between the host device and the storage device;
generating, by the host device, the master key;
providing, by the host device, the master key to the storage device through the secure channel; and
deleting, by the host device, the secure channel.

7. The method of claim 6, wherein each of the host device and the storage device supports SPDM (Security Protocol and Data Model) security protocol and IDE (Integration and Data Encryption) key management security protocol of PCIe (Peripheral Component Interconnect express) IDE (Integrity and Data Encryption) standard,
wherein the secure channel is established by using the SPDM security protocol,
wherein the master key is generated by using random number generation, and
wherein the master key is provided from the host device to the storage device by using the IDE key management security protocol.

8. The method of claim 1, wherein the first information comprises a series of values uniquely generated by the host device for the first user with respect to the first device function.

9. The method of claim 1, wherein the providing of the first information comprises:
establishing, by the host device, a secure channel between the first user of the host device and the first device function of the storage device;
generating, by the host device, the first information of the first user; and
providing, by the host device, the first information to the storage device through the secure channel; and
wherein the method further comprises:
after generating the first host encryption key, deleting, by the host device, the secure channel.

10. The method of claim 1, wherein the generating the first host encryption key comprises:
generating, by the host device, first unique information by synthesizing the first identification information and the first information;
generating, by the host device, the first host encryption key based on a key derivation operation of the first unique information and the master key using an encryption key derivation algorithm; and
storing, by the host device, the first host encryption key in a host key table of the host device.

11. The method of claim 1, wherein the generating of the first storage encryption key comprises:
generating, by the storage device, first unique information by synthesizing the first identification information and the first information;
generating, by the storage device, the first storage encryption key based on a key derivation operation of the first unique information and the master key using an encryption key derivation algorithm; and
storing, by the storage device, the first storage encryption key in a storage key table of the storage device.

12. The method of claim 1, wherein the performing the encrypted first data communication comprises:
generating, by the host device, a write request for target data;
generating, by the host device, encrypted target data by encrypting the target data by using the first host encryption key; and
providing, by the host device, the encrypted target data to the storage device.

13. The method of claim 1, wherein the performing the first data communication encrypted comprises:
providing, by the host device, a read request to read target data to the storage device;
receiving, by the host device, encrypted target data, wherein the encrypted target data is generated by the storage device based on the read request and is generated using the first storage encryption key;
restoring, by the host device, the target data by decrypting the encrypted target data by using the first host encryption key; and
providing, by the host device, the target data to the first user of the host device.

14. The method of claim 1, wherein the first user is a user of a virtual machine running on a hypervisor of the host device, and
wherein the method further comprises:
terminating, by the host device, the virtual machine corresponding to the first user after generating the first host encryption key; and
providing, by the host device, a request to the storage device to delete the first device function based on terminating the virtual machine.

15. The method of claim 1, further comprising:
provisioning, by the host device, a virtual machine for a third user after generating the first host encryption key;
providing, by the host device, a request to the storage device to create a third device function for the third user based on executing the virtual machine;
providing, by the host device, third information of the third user to the storage device;
generating, by the host device, a third host encryption key based on the third identification information, the third information, and the master key,
wherein a series of values of the third host encryption key are equal to the series of values of a third storage encryption key,
wherein the third storage encryption key is generated by the storage device and is based on the third identification information, the third information, and the master key,
wherein a series of values of the third storage encryption key are different from the series of values of the first storage encryption key;
wherein the third host encryption key and the third storage encryption key are associated with the third device function; and
performing, by the host device and with the storage device, an encrypted third data communication between the virtual machine for the third user and the third device function by using the third host encryption key and the third storage encryption key.

16. An electronic device, comprising:
a host device comprising a hypervisor, the host device configured to generate identification information corresponding to a first device function among one or more device functions of a storage device, generate a master key, and generate user secure information; and
the storage device comprising the one or more device functions, wherein the storage device is configured to assign the identification information to the first device function among the one or more device functions, and store the user secure information received from the host device and store the master key received from the host device,
wherein the host device generates a host encryption key based on the identification information, the user secure information, and the master key,
wherein the host encryption key is associated with the first device function,
wherein the storage device generates a storage encryption key based on the identification information, the user secure information, and the master key,
wherein the storage encryption key is associated with the first device function,
wherein a series of values of the host encryption key are equal to a series of values of the storage encryption key, and
wherein the host device and the storage device are configured to perform an encrypted first data communication between the host device and the first device function using the host encryption key and the storage encryption key.

17. The electronic device of claim 16, wherein the hypervisor runs a hypervisor operating system and a plurality of virtual machines,
wherein the user is a user of the hypervisor operating system or a user of a first virtual operating system of a first virtual machine among the plurality of virtual machines,
wherein the encrypted first data communication between the host device and the first device function is performed between the hypervisor operating system and the first device function or the first virtual operating system and the first device function,
wherein the storage device supports SR-IOV (Single Root Input/Output Virtualization), and
wherein the one or more device functions comprises:
a physical function (PF) configured to manage transmission of data of the hypervisor operating system; or
a virtual function (VF) configured to manage transmission of data of one of the plurality of virtual operating systems of the plurality of virtual machines.

18. The electronic device of claim 16, wherein the electronic device further comprises a plurality of interface buses,
wherein the identification information comprises:
bus identification information indicating an interface bus connected to the storage device, the interface bus being among the plurality of interface buses;
device identification information indicating the storage device, the storage device being among at least one storage devices connected to the interface bus corresponding to the bus identification information; and
function identification information indicating the first device function among the one or more device functions of the storage device, and
wherein the user secure information comprises a series of values uniquely generated by the host device for the user with respect to the first device function.

19. A storage device configured to communicate with a host device, the storage device comprising:
one or more device functions, the one or more device functions comprising a first device function, the first device function having first identification information assigned to it by the host device; and
at least one memory for receiving a master key from the host device and storing instructions; wherein the instructions when executed by one or more processors, cause the storage device to:
receive first secure information of a first user from the host device;
generate a first storage encryption key based on the first identification information of the function manager, the first secure information, and the master key of the storage key table; and
perform a first encrypted data communication between the host device and the first device function by using the first storage encryption key and a first host encryption key,
wherein a series of values of the first host encryption key are equal to a series of values of the first storage encryption key, and
wherein the first host encryption key and the first storage encryption key are associated with the first device function.

20. The storage device of claim 19, wherein the storage device further comprises a second device function having second identification information, wherein the second identification information is assigned to the second device function by the host device,
wherein instructions further cause the storage device to:
receive second secure information of a second user from the host device;
generate a second storage encryption key based on the second identification information of the function manager, the second secure information, and the master key of the storage key table; and
perform a second encrypted data communication between the host device and the second device function by using the second storage encryption key and a second host encryption key, and
wherein a series of values of the second storage encryption key are different from the series of values of the first storage encryption key, and
wherein the second host encryption key and the second storage encryption key are associated with the second device function.
